(19) United States
(12) Patent Application Publication
(10) Pub. No.: US 2016/0198071 A1
(43) Pub. Date: Jul. 7, 2016

(54) COMPLIANT SUPPORT FOR COMPONENT ALIGNMENT

(71) Applicant: Microsoft Technology Licensing, LLC, Redmond, WA (US)

(72) Inventors: Eric Leong, Kirkland, WA (US); Michael Schweers, Seattle, WA (US)

(21) Appl. No.: 15/069,222

(22) Filed: Mar. 14, 2016

Related U.S. Application Data
(63) Continuation-in-part of application No. 14/187,181, filed on Feb. 21, 2014.

(51) Int. Cl. H04N 5/225; B32B 38/18

(52) U.S. Cl. CPC H04N 5/2252; B32B 38/18; B32B 2305/77

(57) ABSTRACT

Compliant supports hover a cover having a pressure sensitive adhesive (PSA) applied to bottom surface over a housing to enable precise alignment of the cover to the housing. The compliant supports are placed along a surface of the housing and in respective cavities formed in the surface. The cavities enable locating the compliant supports and enclosing the compliant support after assembly of the enclosure. At least a portion of each of the compliant supports extends above the surface of the housing to hover the cover above the housing such that the PSA does not contact the housing. The compliant supports apply an upward force on the cover to maintain a gap between the cover and the housing. After alignment of the cover to the housing, the cover is brought into contact with the housing while retaining at least one of the compliant supports in the cavity of the housing.

### BACKGROUND

Mobile computing devices provide various functionality in a limited device space or form factor. In particular, such devices are thin and light. In some devices, pressure sensitive adhesive (PSA) is used to hold a cover, such as a front window or cover glass, to a device enclosure or housing. The cover may be a cosmetic feature of the computing device. The alignment of the cover to the housing may be an important aesthetic feature where any misalignment could cause unwanted edges to be seen and could reduce the value of the product.

In some existing assembly processes, complicated and expensive robotic production equipment with vision systems are used to perform the alignment between the cover and the housing. Machine Vision systems are generally used for such alignment due to the use of PSA. Visible features on the cover and the housing are separately captured by the vision system and used to align the cover and the housing on top of each other before bringing the parts together to activate the PSA. Once the PSA is activated, the parts are not able to be moved. Thus, with the existing assembly processes, there is associated an increased cost of assembly due to the use of robotic machine vision systems.

### SUMMARY

In one aspect of the disclosure, an imaging device is provided. The imaging device includes a housing defining an interior space. The housing includes an edge defining at least a portion of an opening to the interior space, and a cavity formed in the edge. The imaging device also includes a cover positionable at least in part on the edge of the housing, where the cover overlaps the cavity. Moreover, the imaging device includes a compliant support positioned in the cavity. The compliant support is configured to provide a first force to maintain the cover in a spaced relationship relative to edge. In addition, the imaging device includes an adhesive component that is positioned between at least a portion of the edge and the cover. The adhesive component is configured to bond the portion of the edge to the cover via the adhesive component when a second force is applied to overcome the first force. The compliant support is retained in the cavity.

Aspects of the disclosure provide an enclosure assembly having a housing including a surface having a plurality of cavities formed therein. The enclosure assembly also includes a cover positionable on the surface and overlapping the plurality of cavities. In addition, the enclosure assembly includes a plurality of compliant supports. A respective one of the compliant supports is positioned in a respective one of the plurality of cavities. The plurality of compliant supports being configured to extend beyond the first surface and being configured to provide a first force to facilitate maintaining the cover in a spaced relationship relative to the housing. Furthermore, the enclosure assembly includes an adhesive component positioned between the cover and the surface of the housing. The adhesive component is configured to bond the cover to the surface via the adhesive component when a second force is applied to overcome the first force. The plurality of compliant supports are retained in the plurality of cavities after assembly of the enclosure assembly.

Further aspects of the disclosure also provide a method of assembling an enclosure assembly. The method includes coupling a compliant support to a housing. The compliant support is positioned in a cavity formed in a surface of the housing and extends beyond the surface. The method also includes placing a cover onto the compliant support. The compliant support maintains a gap between the cover and the housing. The method includes bonding an adhesive component to one of the housing and the cover in the gap. The gap defines a spaced relationship between the adhesive component and the other of the housing and the cover. In addition, the method includes aligning the cover to the housing through translational movement of the cover via the compliant support. Furthermore, the method includes bonding the cover to the housing via the adhesive component by bringing the cover and the housing into contact with the adhesive component without removing the compliant support from the enclosure assembly.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings.

FIG. 1 is a perspective view of one example of an exemplary enclosure.

FIG. 2 is an exploded schematic of the enclosure of FIG. 1 illustrating a housing having a cover, a general arrangement of compliant supports, and an adhesive component.

FIG. 3 is an exemplary schematic of the enclosure of FIG. 2, illustrating nine compliant supports spaced about the top edge of the housing in predefined locations.

FIG. 4 is a sectional view of the enclosure taken along line A-A of FIGS. 2 and 3.

FIGS. 5A and 5B illustrate one example of the compliant supports shown in FIG. 4.

FIG. 6 is an enlarged sectional view of the enclosure shown in FIG. 4 having the cover and PSA removed.

FIG. 7 is a sectional view of the enclosure taken along line A-A shown in FIGS. 2 and 3 illustrating the cover installation onto the housing after satisfactory alignment and bonding.

FIG. 8 illustrates a flowchart describing a method of assembling an enclosure assembly in accordance with some of the described examples.

### DETAILED DESCRIPTION

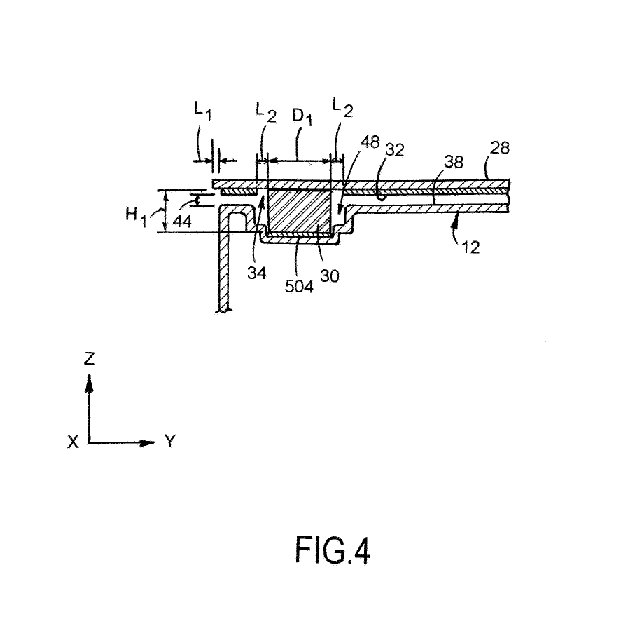

Referring to the figures, examples of the disclosure enable the positioning and alignment of a cover of an enclosure while preventing contact with an adhesive component, such as a pressure sensitive adhesive (PSA). In some examples, compliant supports are disposed along a surface or an edge of a housing to hold the cover away from the housing for alignment. The compliant supports compress slightly when the cover is placed on the compliant supports, and produce an upward force (e.g., a first force) to support the cover and PSA above the housing 12 as shown, for example, in FIG. 4.

Aspects of the disclosure enable the cover to be placed in a location that is proximate or otherwise near to the desired final location of the cover on the housing of the enclosure. The compliant supports further enable translational movement of the cover in X and Y directions, as well as rotational movement in a Z direction. This movement capability imparts an ability to maneuver the placed cover to enable repositioning for precise alignment with the housing of the enclosure. Furthermore, in some suitable examples, none of the compliant supports are removed during final fitment of the cover during assembly. A predefined amount of pressure (e.g., 20 pounds per square inch) is applied to the cover to generate a force (e.g., a second force) that overcomes the force exerted by the compliant supports. The cover, having the PSA attached to its mating surface, then comes into contact with the housing for bonding to the housing without removing any of the compliant supports. The pressure is maintained for a predefined period of time (e.g., 30 seconds). The applied pressure compresses the compliant supports (e.g., further) to shrink the compliant supports and to enable the cover to be bonded to the housing via the PSA.

Additionally, in some suitable examples, because no removable fixtures are used for the fitment of the cover, no time-consuming, skilled, and potentially damaging operations need to be performed. In this manner, aspects of the disclosure facilitate reducing the cost of assembly because the cover may be aligned by hand, negating the need to use expensive machine vision assembly equipment.

Although generally described herein with respect to an enclosure housing an imaging device, the methods and systems described are applicable to any type or form of enclosure or device that includes a first component to be aligned with a second component, for example, various mobile computing devices such as mobile phones, personal digital assistants, pagers, tablets, messenger devices, hand-held computing devices, pocket translators, e-books, bar code readers, smart phones, computing pads, netbooks, gaming devices, portable media players, head-mounted devices, and the like. The device may also include less portable devices such as desktop personal computers, kiosks, tabletop devices, industrial control devices, wireless charging stations, and electric automobile charging stations.

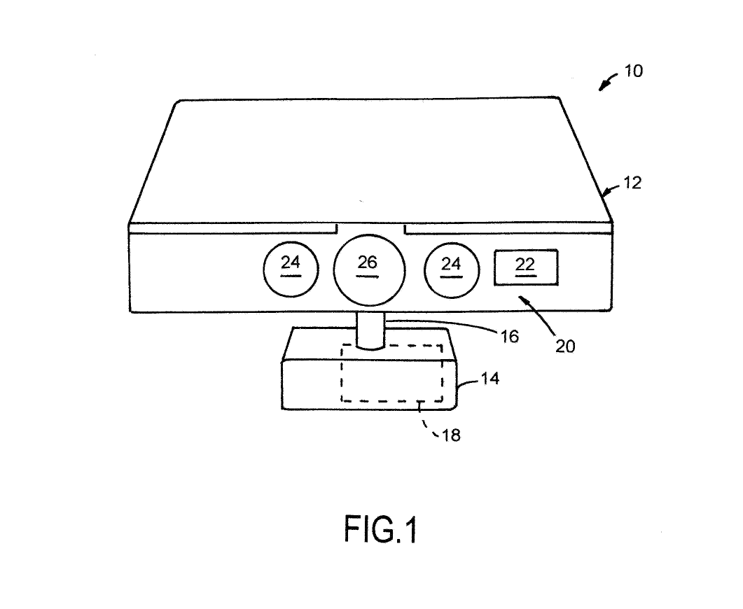

FIG. 1 is a perspective view of one example of an exemplary enclosure 10. The enclosure 10 illustrated in FIG. 1 is, for example, an imaging device that may include, without limitation, a tablet computing device, a mobile telephone, a gaming console, and a laptop computing device. In the illustrated example, the enclosure or imaging device 10 defines an enclosure assembly that includes a housing 12 that is connected to a base 14 by a mounting arm 16. The base 14 may contain a motor 18 that enables the position of the mounting arm 16 to be changed in order to change the orientation of the housing 12. A first portion of the mounting arm 16 may be moveably connected to the motor 18 such that the mounting arm 16 may be moved by the motor 18. A second portion of the mounting arm 16 may be fixedly connected to the housing 12. In other suitable examples, the imaging device 10 may include the housing 12 free of the base 14 and mounting arm 16. In such examples, the orientation of the housing 12 may be adjusted manually by an end user (not shown) of the imaging device 10.

In the illustrated example, the housing 12 includes an array of image components 20 including a light transmitter 22, one or more light sensors 24, and a red-green-blue (RGB) camera 26 that may be used to capture depth information of a scene (not shown). In another suitable example, the one or more light sensors 24 of the imaging device 10 may include two or more physically separated light sensors 24 that view a scene from different angles to obtain visual stereo data that may be resolved to generate depth information. In some suitable examples, the imaging device 10 uses the captured depth information to determine how to change the orientation of the housing 12.

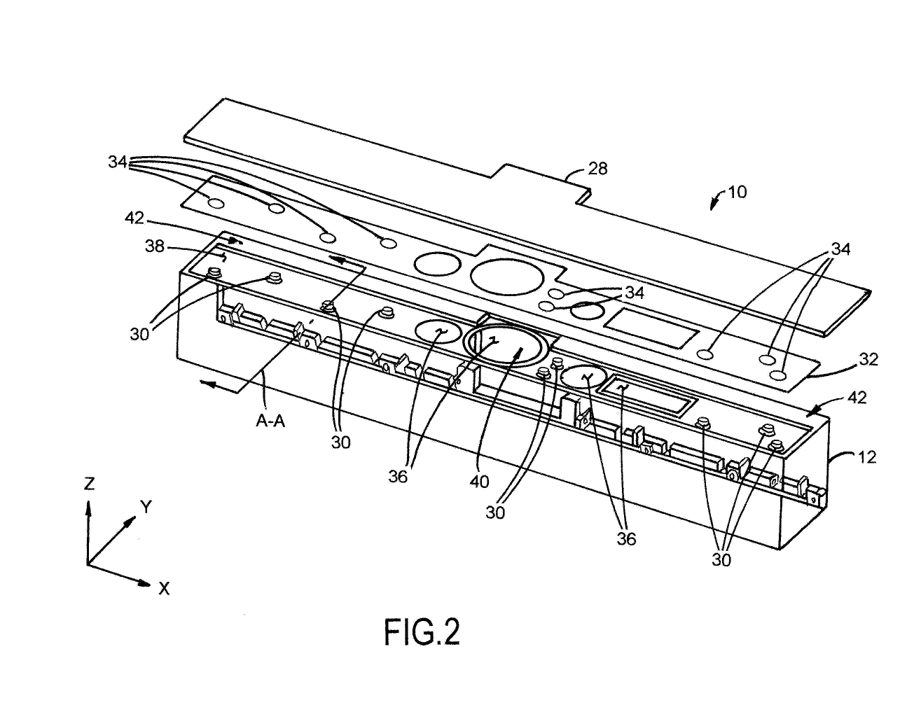

FIG. 2 is an exploded schematic of the enclosure shown in FIG. 1 illustrating the housing 12 having a cover 28, a general arrangement of compliant supports 30, and an adhesive component 32. The adhesive component 32 includes the desirable adhesive properties for an effective bond between components of the imaging device 10. The term “adhesive properties” is used herein to refer to the property of any substance, inorganic, organic, natural or synthetic, that is capable of bonding other substances together by surface attachment. In the instant situation, this refers to the ability of the adhesive component 32 to hold together the surfaces of the cover 28 and the housing 12. Adhesive component 32 may be a pressure sensitive adhesive (“PSA”), a liquid adhesive (e.g., liquid glue), or a heat activated film (HAF).

In the exemplary example, the adhesive component 32 is a PSA. The adhesive component or PSA 32 may, in some examples, include a top release liner (not shown) and a bottom release liner (not shown) that are removed when the PSA 32 is applied to the cover 28 and/or the housing 12. PSA 32 is positioned between at least a portion of the housing 12 and the cover 28. As illustrated in FIG. 2, a plurality of holes 34 is formed through the PSA 32. The holes 34 correspond to the locations of the compliant supports 30. A size and shape of the holes 34 is configured to enable the compliant supports 30 to pass through the holes 34 without coming into contact with the PSA 32. In some suitable examples, a size and shape of a respective one of the holes 34 may be optimized to facilitate reducing the space between the PSA 32 and a respective one of the compliant supports 30.

As shown in FIG. 2, the housing 12 includes a plurality of openings 36 defined through a top edge 38 of the housing 12. While the housing 12 is illustrated with a plurality of openings 36, it is contemplated that in some examples, the housing 12 may include a single opening or any number of openings that enable the enclosure to function as described herein. Moreover, in some examples, the housing 12 may not include any openings. In the illustrated example, the openings 36 open to an interior space 40 of the housing 12. The interior space 40 is configured to receive the array of image components 20, including the light transmitter 22, the one or more light sensors 24, and the red-green-blue (RGB) camera 26 used to capture depth information of the scene. Furthermore, the housing 12 may further include one or more audio recording devices 42, although it is contemplated that in some examples, the audio recording devices 42 may be omitted.

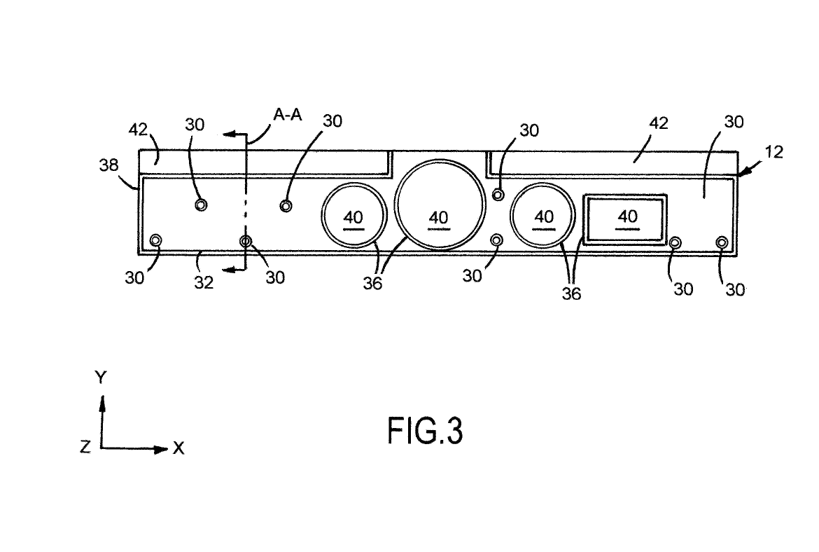

FIG. 3 is an exemplary schematic of the enclosure of FIG. 2, illustrating nine compliant supports 30 spaced about the top edge 38 of the housing 12 in predefined locations. It is contemplated, however, that more than or less than nine compliant supports 30 may be used. The compliant supports 30 are shown in FIG. 3 as circles. However, aspects of the disclosure are operable with various other shapes and sizes of the compliant supports 30. Further, while the compliant supports 30, openings 36, and audio recording devices 42 are illustrated in FIG. 3, other exemplary items or component features may be visible or invisible on the imaging device 10. For example, FIG. 3 illustrates the PSA 32, positioned in its designated location, to be used for bonding of the housing 12 to the cover 28. For clarity, however, the cover 28 is not shown in FIG. 3.

In operation, in some suitable examples, the PSA 32 is attached to the cover 28. The cover 28 is placed on the compliant supports 30. The cover 28, when engaged with the compliant supports 30, is supported by and attachable to the compliant supports 30, but floats above the edge 38 of the housing 12. Thus, the PSA 32 is prevented from contacting the edge 38. In other suitable examples, the PSA 32 may be attached to the edge 38 of the housing 12. In such other examples, the cover 28 floats above the PSA 32. In the exemplary example, the compliant supports 30 are firm enough to suspend the weight of the cover 28 to prevent contact between the PSA 32 and the edge 38 of the housing 12, but compliant enough to not exert a repelling force when compressed that exceeds a bonding strength of the PSA 32 (e.g., when the edge 38 is bonded to the PSA 32). A repelling force that exceeds the bonding strength of the PSA 32 may reduce the strength of the bond between the cover 28 and the edge 38 during assembly and use of the imaging device 10. In some suitable examples, a predefined and optimized gap 44 (not shown in FIG. 3), such as a gap in the range between about 0.008 inches (in.) (0.2 millimeters (mm)) and about 0.24 in (0.6 mm) may be maintained between the PSA 32 and the edge 38 of the housing 12 during positioning and assembly of the cover 28. Gap 44 is determined based on several factors, including for example, without limitation, the flexibility and/or weight of the cover 28, the size and shape of the compliant supports 30, the material of the compliant supports 30, the quantity of compliant supports 30 used, the density of the compliant supports 30, and the compression modulus of the compliant supports 30.

The cover 28 is translatable in the X and Y directions while resting on the compliant supports 30. In addition, the cover 28 is translatable in the Z direction upon application of a threshold force. During assembly of the imaging device 10, the cover 28 is placed proximate to its final designated position, although it may not be precisely aligned with such position. Because the compliant supports 30 are flexible (i.e., compliant) and function to support the cover 28 such that it is not touching the housing 12, aspects of the disclosure enable the cover 28 to have translational and rotational maneuverability. This maneuverability enables the cover 28 to be aligned with and positioned above its final designated position with respect to the housing 12 before bonding with the housing 12.

Referring back to FIG. 3, while an exemplary quantity of nine compliant supports 30 that may be used in some suitable examples, is illustrated, it is contemplated that more than or less than nine compliant supports 30 may be used. Further, while all the compliant supports 30 may have the same basic dimensions in some suitable examples, one or more of the compliant supports 30 may have different shapes, sizes, dimensions, materials, and/or other properties in other suitable examples. Further, while the PSA 32 is shown as a unitary component in FIG. 3, the PSA 32 may include a plurality of pieces of PSA material.

FIG. 4 is a sectional view of the enclosure taken along line A-A shown in FIGS. 2 and 3 illustrating the cover 28 positioned on the compliant support 30, but with an overhang distance “L₁” with respect to the housing 12. The compliant support 30 has a diameter “D₁” and a thickness, or height, “H₁” that are suitably chosen, based on several enumerated factors described herein, to provide adequate gap 44 and force to support the cover 28 during alignment and assembly. As described herein, in some suitable examples, the gap 44 is in the range between about 0.008 in. (0.2 mm) and about 0.24 in (0.6 mm). The compliant support 30 is positioned in a cavity 48 that is formed in the edge 38 of the housing 12. The cavity 48, described further herein, is shaped and sized to facilitate positioning the compliant support 30 on the edge 38 of the housing 12, and accommodating the growth in the diameter “D₁” of the compliant support 30 when the compliant support 30 is compressed after bonding the cover 28 to the edge 38 of the housing, thereby enabling the compressed compliant supports 30 to be retained in the cavity 48 after assembly of the imaging device 10.

As illustrated in FIG. 4, the hole 34 through the PSA 32 is sized to enable the compliant support 30 to pass through the hole 34 without coming into contact with the PSA 32. The hole 34 is sized such that it is spaced from an edge of the compliant support 30 by a length “L₂”. In the illustrated example, the length “L₂” is larger than the overhang distance “L₁” of the cover 28 with respect to the housing 12. This relative difference in distances enables the cover 28 to be translated in the X or Y directions to facilitate alignment with the housing 12, such that the overhang distance “L₁” is reduced to substantially 0.0 in (0.0 mm). In some suitable examples, the translation of the cover 28 in the X and Y directions for final alignment may be accomplished by hand by a human assembler. In other suitable examples, the final alignment of the cover 28 may be accomplished by the use of a mechanical alignment fixture. Furthermore, the final alignment of the cover 28 may be accomplished by a robotic assembly system using an optical system to alignment the cover with the housing 12 prior to bonding.

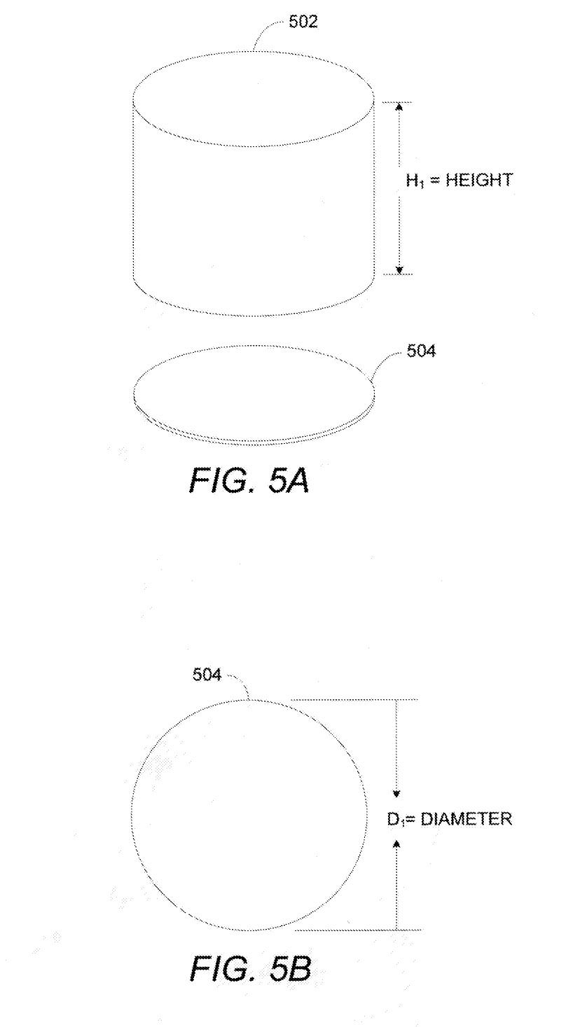

FIGS. 5A and 5B illustrate an exemplary example of the compliant supports 30 shown in FIG. 4. In the illustrated example, a cylindrical piece of foam 502 is used as the compliant support. In one suitable example, the material used for the cylindrical piece of foam 502 is a semi-closed cell ethylene propylene diene monomer (EPDM) rubber foam. For example, in the exemplary example, the material is Nitto Denko EE-1000L series foam sealer available from Nitto Denko of Japan. The diameter of the compliant supports 30 is “D₁,” and the thickness, or height, of the compliant supports 30 is “H₁.” The compliant supports 30 in this implementation have a double-sided adhesive component 504 applied to the foam 502, for example, without limitation, an acrylic adhesive PSA backing, a butyl adhesive PSA backing, and the like. The use of the adhesive component 504 facilitates attaching the compliant supports 30 to the cavities 48 defined in the edge 38 of the housing 12. In some suitable examples, a Nitto Denko double-sided PSA backing is used for this purpose.

The range of the diameter “D₁” and the height “H₁” of the compliant supports 30 may vary substantially depending upon the size of the imaging device 10, the size, shape, and weight of the cover 28, space available in the edge 38 of the housing 12, and other factors. In one example, the diameter “D₁” is about 0.197 in. (5 mm) and the height “H₁” is about 0.394 in (10 mm) (when uncompressed). The thickness of the PSA 32 is an example of one of the criteria used to determine the height “H₁.” Substantial variations in dimensions, however, are possible in other examples of the disclosure without causing any problem in mechanical assembly of the imaging device 10. For example, a compliant support 30 may have any shape, irregular or regular.

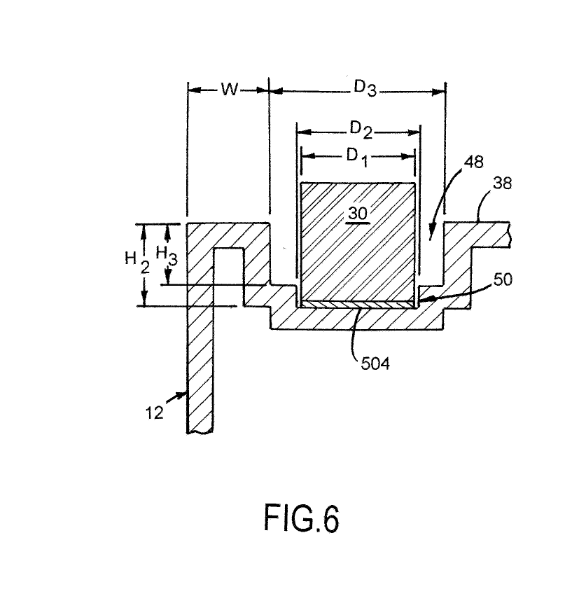

In an exemplary case where the material of the compliant supports 30 is Nitto Denko EE-1000L and the values of “D₁” and “H₁” are 5 mm and 10 mm, exemplary calculations for determining a depth of the cavity 48 (shown in FIG. 6) and an upward force exerted by the compressed compliant supports 30 are described. The compressive strength of Nitto Denko EE-1000L foam at 25% compression is approximately 0.0078 N/mm². The area of each compliant support 30 is shown in Equation (1) below.

π×(2.5 mm)²=19.64 mm² (1)

The area of nine compliant supports 30 is shown in Equation (2) below.

9×19.64 mm²=176.76 mm² (2)

The upward force exerted by the nine compliant supports 30 at 25% compression is shown in Equation (3) below.

$$0.0078 \frac{N}{{mm}^{2}} \times 176.76 {mm}^{2} = 1.38 N \qquad ( 3 )$$

In one example, assuming a weight of the cover 28 at 230 grams is approximately 2.26 N, and assuming a linear compression rate of the compliant supports 30, the compliant supports 30 are compressed as shown in Equation (4) below.

(2.26 N/1.38 N)×2.5 mm=4.1 mm (4)

Hence, to set the actual gap 44 (shown in FIG. 4) between the PSA 32 (assuming the thickness of the PSA 32 is 0.2 mm) attached to the cover 28 and the edge 38 of the housing 12 in the range between about 0.2 mm and about 0.6 mm, as described herein, a depth of the cavity 48 is shown in Equations (5) and (6) below.

10 mm−4.1 mm−0.2 mm−0.2 mm=5.2 mm (5)

10 mm−4.1 mm−0.2 mm−0.6 mm=5.1 mm (6)

In some suitable examples, when the cover 28 is bonded to the PSA 32, the compliant supports 30 may be compressed to about 50% of the height “H₁” and exert a rebound pressure against the bonded cover 28 low enough to not weaken the integrity of the bond. Aspects of the disclosure are operable with materials having various ranges of compression. For example, some examples have an acceptable range of compression of up to 80%.

The above exemplary calculations show that a wide range of dimensions (e.g., thicknesses) of the compliant supports 30 and cavity 48 depth may be used with the disclosure. The Nitto Denko EE-1000L foam is available at least in thickness in the range between about 3.0 mm to about 30 mm. Accordingly, any suitable thickness may be chosen based on various factors, such as the weight of a given cover, the space available in a given housing, suitable values for dimensions “D₁” and “H₁,” and the quantity of compliant supports 30 to be used. Any other suitable material (e.g., Nikko Denko SCF200, Nikko Denko SCF400, Nikko Denko SCF T100, or Nikko Denko P1500, or similar rubbers and foams from other manufacturers) may be used to fabricate the compliant supports 30.

While the compliant supports 30 are described herein as having a cylindrical shape, it is contemplated that other suitable shapes may be used. For example, without limitation, quadrilateral shapes (e.g., rectangular, square, etc.), spherical shapes, oval shapes, and the like may be used. These shapes facilitate translation of the cover 28 in situ. In some examples, the spherical-shaped and oval-shaped compliant supports may be made of a suitable plastic or rubber material and filled with a second material, such as air, a suitable fluid, or other suitable material. The spherical-shaped and oval-shaped compliant supports provide are strong enough to support the weight of the cover 28. When compressed, however, the compliant supports may break or burst, thus enabling the cover 28 to be bonded to the housing 12 as described herein. In one suitable example, the fluid contained in the compliant supports may be an adhesive that comes in contact with the PSA 32 and the cover 28 to provide further bonding between the cover 28 and the housing 12.

In addition to a wide variety of shapes, the compliant supports 30 may also be provided in any number of sizes, thicknesses, and materials. The quantity of pieces of the compliant supports 30 to be used may be selected at least based on the weight and size of the cover 28, the space available in the housing 12, the material selected for the compliant supports 30, and the production expediency.

FIG. 6 is an enlarged sectional view of the enclosure shown in FIG. 4 having the cover 28 and PSA 32 removed. The compliant support 30 is positioned in the cavity 48 that is formed in the edge 38 of the housing 12. In the exemplary example, the cavity 48 is circular in shape, corresponding to the shape of the compliant supports 30. In other suitable examples, the shape of the cavity may be any shape that enables the imaging device 10 to function as described herein. In the exemplary example, the cavity includes a first diameter “D₂” having a first height “H₂,” and a second diameter “D₃” having a second height “H₃.” As illustrated, the first height “H₂” extends beyond the third height “H₃.” Furthermore, the second diameter “D₂” is less than the third diameter “D₃.” This geometry of the cavity 48 enables the cavity 48 to include a locating feature 50 formed in a bottom of the cavity 48. The locating feature 50 is substantially centered in cavity 48, thereby facilitating locating the compliant supports 30 substantially center in the cavity 48.

The diameter “D₂” is sized to be slightly larger than the diameter “D₁” of the compliant supports 30. The diameter “D₂” is determined at least based on the manufacturing tolerances of the compliant supports 30 and the tolerances associated with the formation of the locating feature 50. This enables placement of the compliant supports 30 into the locating feature 50 of the cavity 48. Furthermore, the diameter “D₃” is sized to enable the compliant supports 30 to expand under compression while remaining within the cavity 48. For example, when the compliant supports 30 are compressed to bond the cover 28 to the edge 38 of the housing 12, thereby bringing the height “H₁” to be substantially the same as height “H₂,” the diameter “D₁” may expand. The diameter “D₃” is sized to accommodate such an expansion. The diameter “D₃” is determined at least based on the expansion properties of the material used to fabricate the compliant supports 30 and the tolerances associated with the formation of the cavity 48.

An edge of diameter “D₃” of the cavity 48 is located a predefined distance “W” from an edge of the housing 12. The distance “W” is determined, at least in part, based on properties of the material used to fabricate the housing 12. The distance “W” is used to facilitate reducing stress and the potential for material failure in the housing 12 as the cavity 48 is formed near the edge.

While the housing 12 illustrated in FIG. 6 is depicted as a thin-walled component, it is contemplated that the housing 12 may be fabricated from any suitable material that enables the housing 12 to function as described herein. For example, the housing 12 may be fabricated from a block of material such that the cavity 48 is formed, example, by boring, drilling, or otherwise removing material from the block of material.

With reference back to FIG. 4, the compliant supports 30 are attached to the edge 38 of the housing 12 using, for example, the adhesive component 504. The compliant supports 30 exert sufficient force to support the cover 28 above the PSA 32. In this condition, there is adequate gap 44 between the PSA 32 and the edge 38 of the housing 12. The cover 28 is moveable to align with the housing 12 and to bond with the edge 38 of the housing 12. The cover 28 engages the compliant supports 30 such that there is little risk of unintentionally separating the cover 28 from the compliant supports 30 or the housing 12. However, if during alignment and assembly of the imaging device 10, some rectification or other repair to the imaging device 10 is desired, the cover 28 may be removed from the housing 12 without any damage to the cover 28, the housing 12, and/or any other components of the imaging device 10.

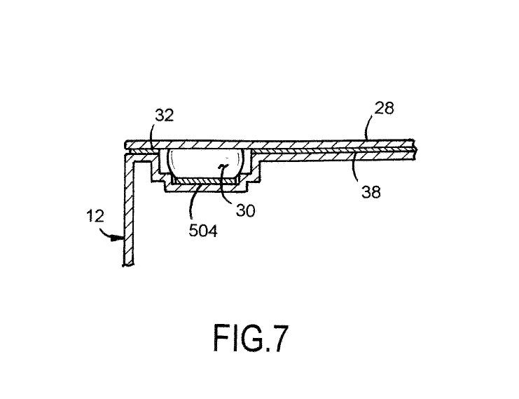

FIG. 7 is a sectional view of the enclosure taken along line A-A shown in FIGS. 2 and 3 illustrating the cover 28 installation onto the housing 12 after satisfactory alignment and bonding. After the cover 28 is satisfactorily aligned with the housing 12, the cover 28 may be bonded to the edge 38 of the housing 12 using the PSA 32. In some suitable examples, for imaging device 10 assembly, a predetermined amount of force is applied to the cover 28 to bring the cover 28 into intimate contact with the edge 38. The predetermined force may be applied for a predefined period of time to facilitate the bonding process. The compliant supports 30 compress and the cover 28 with the PSA 32 attached is held in directed contact with the edge 38 of the housing 12 by the predetermined force for a period of time (e.g. 30 seconds) sufficient to produce a bond between the PSA 32 and the housing 12. The upward force exerted on the cover 28 by the compliant supports 30 in the compressed state is less than the bonding force produced between the PSA 32 and the cover 28, and the PSA 32 and the edge 38 of the housing 12, such that the cover 28 remains bonded to the housing 12 when the compliant supports 30 are compressed. Accordingly, the cover 28 is bonded to the housing 12 through the agency of the PSA 32.

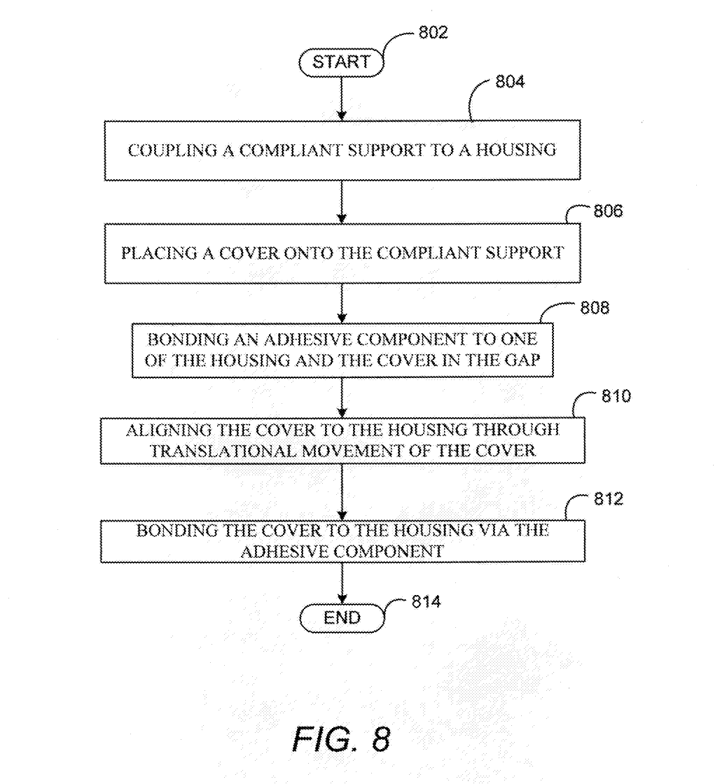

FIG. 8 illustrates a flowchart describing a method of assembling an enclosure assembly in accordance with some of the described examples. As shown in FIG. 8, the method begins at 802. At 804, the compliant support 30 is coupled to the housing 12. The compliant support 30 is positioned in the cavity 48 formed in a surface, or the edge 38 of the housing 12. The compliant support 30 is size to extend beyond the edge 38 of the housing 12. At 806, the cover 28 is placed onto the compliant support 30. The compliant support 30 is strong enough to exert a force on the cover 28 to maintain the gap 44 between the cover 28 and the housing 12. At 808, an adhesive component, or PSA 32 is bonded to one of the edge 38 of the housing 12 and the cover 28 in the gap 44. The gap 44 defines a spaced relationship between the PSA 32 and the other of the housing 12 and the cover 28. At 810, the cover 28 is aligned to the housing 12 through translational movement of the cover 28 via the compliant support 30. At 812, the cover 28 is bonded to the housing 12 via the PSA 32 by bringing the cover 28 and the housing 12 into direct contact with the PSA 32. To bring the cover 28 and the housing 12 into contact with the PSA 32, a compressive force is provided to one or more of the housing 12 and the cover 28 to overcome the force exerted by the compliant support 30 on the cover 28. The compliant support 30 is compressed into the cavity 48, where it is retained after assembly of the enclosure assembly. At 814, the method ends.

### Additional Examples

In one suitable example, the compliant supports 30 are in the form of breakaway supports of suitable material that support the weight of the cover 28, but breakaway and remain under the cover 28 during bonding of the cover 28 to the housing 12 after assembly.

In another suitable example, springs of a light, thin material are lightly attached to the housing 12 and the cover 28. The springs may be used as compliant supports 30 to support the weight of the cover 28 during alignment but compress during bonding of the cover 28 to the housing 12 after assembly.

While some examples have described bonding the cover 28 to the housing 12 by pressing the cover 28 onto the edge 38 of the housing 12 and compressing the compliant supports 30, other examples are contemplated. For example, rather than using pressure, the compliant supports 30 may compress, collapse, and/or disintegrate in response to the application of sound (e.g., ultrasound), light (e.g., ultraviolet light), electrical current, and/or heat. Alternatively, or in addition, the compliant supports 30 may be formed from self-assembling microelectromechanical systems (MEMS) or using nanotechnology.

Alternatively, or in addition to the other examples described herein, examples may include an imaging device including a housing defining an interior space. The housing may include an edge defining at least a portion of an opening to the interior space, and a cavity formed in the edge. The imaging device may also include a cover positionable at least in part on the edge of the housing, where the cover overlaps the cavity. Moreover, the imaging device may include a compliant support positioned in the cavity. The compliant support may be configured to provide a first force to maintain the cover in a spaced relationship relative to edge. In addition, the imaging device may include an adhesive component that is positioned between at least a portion of the edge and the cover. The adhesive component may be configured to bond the portion of the edge to the cover via the adhesive component when a second force is applied to overcome the first force. The compliant support may be retained in the cavity. The imaging device may also include one or more of the following features.

The compliant support may be fabricated from a compressible material. For example, in one suitable example, the compressible material may be a semi-closed cell EPDM rubber foam.

In some examples, the compliant support may include a cylindrical structure having a first end and a substantially parallel second end. In one suitable example, one of the first and second ends may include an adhesive backing material to facilitate attachment of the compliant support.

In some examples, the compliant support is further configured to facilitate translational movement of the cover relative to the housing. For example, the compliant support may be configured to facilitate alignment of the cover to the housing.

In other examples, the adhesive component may be bonded to one of the housing and the cover, and the compliant support may be further configured to provide the first force to maintain the spaced relationship between the adhesive component and the other of the housing and the cover.

In some suitable examples, the adhesive component may include one or more of the following: a pressure sensitive adhesive, a liquid adhesive, and a heat activated adhesive.

In a suitable example, the interior space is configured to receive at least one imaging component.

In some suitable examples, the imaging device may include one or more of the following: a tablet computing device, a mobile telephone, a gaming console, and a laptop computing device.

Alternatively, or in addition to the other examples described herein, examples may include an enclosure assembly having a housing including a surface having a plurality of cavities formed therein. The enclosure assembly also includes a cover positionable on the surface and overlapping the plurality of cavities. In addition, the enclosure assembly includes a plurality of compliant supports. A respective one of the compliant supports is positioned in a respective one of the plurality of cavities. The plurality of compliant supports being configured to extend beyond the first surface and being configured to provide a first force to facilitate maintaining the cover in a spaced relationship relative to the housing. Furthermore, the enclosure assembly includes an adhesive component positioned between the cover and the surface of the housing. The adhesive component is configured to bond the cover to the surface via the adhesive component when a second force is applied to overcome the first force. The plurality of compliant supports are retained in the plurality of cavities after assembly of the enclosure assembly. The enclosure assembly may also include one or more of the following features.

In one suitable example, the plurality of cavities are spaced about the surface in predefined locations.

In another suitable example, the adhesive component is bonded to the cover. The plurality of compliant supports are further configured to provide the first force to maintain the spaced relationship between the adhesive component and the housing until the second force is applied.

In some suitable examples, the plurality of compliant supports are configured to apply the first force to the cover. The second force is greater than the first force.

In other suitable examples, the enclosure assembly includes one or more of the following: a tablet computing device, a mobile telephone, a gaming console, and a laptop computing device.

Alternatively, or in addition to the other methods described herein, methods may include a method of assembling an enclosure assembly. The method includes coupling a compliant support to a housing. The compliant support is positioned in a cavity formed in a surface of the housing and extends beyond the surface. The method also includes placing a cover onto the compliant support. The compliant support maintains a gap between the cover and the housing. The method includes bonding an adhesive component to one of the housing and the cover in the gap. The gap defines a spaced relationship between the adhesive component and the other of the housing and the cover. In addition, the method includes aligning the cover to the housing through translational movement of the cover via the compliant support. Furthermore, the method includes bonding the cover to the housing via the adhesive component by bringing the cover and the housing into contact with the adhesive component without removing the compliant support from the enclosure assembly. The method of assembling an enclosure assembly may also include one or more of the following operations.

In one suitable example, the compliant support provides a force to the cover to maintain the spaced relationship between the adhesive component and the other of the housing and the cover during alignment of the cover to the housing.

In another suitable example, bringing the cover and the housing into contact with the adhesive component includes providing a compressive force to one or more of the housing and the cover to overcome a force generated by the compliant support.

In some suitable examples, bringing the cover and the housing into contact with the adhesive component without removing the compliant support from the enclosure assembly includes compressing the compliant support extending beyond the surface into the cavity of the housing.

The examples illustrated and described herein as well as examples not specifically described herein but within the scope of aspects of the disclosure constitute exemplary means for assembling the computing device. For example, some examples include adhesive means disposed along a surface of the cover 28 or the edge 38 of the housing 12, and compliant support means disposed along the edge 38 of the housing 12 with at least a portion of the compliant support means extending above the edge 38.

Tablet computers, smartphones, and imaging device are some examples of devices that include enclosures where alignment between the cover and the enclosure is desirable. Moreover, the cost for employing traditional robotic machine vision systems for assembly is substantial. To facilitate reducing the cost of assembly, the cover can be placed on compliant support that hover the cover over the housing near its final position. Alignment can be made via the use of an inexpensive mechanical fixture or via human manual alignment. Advantageously, the device may be enabled to ensure accurate alignment of the cover prior to bonding to the housing. This may be accomplished by translating the cover along the compliant supports, then applying a force to initiate the bonding of the cover to the housing. The assembly process may advantageously reduce the cost of assembly while maintaining accurate alignment of the cover to the housing.

Examples of the disclosure are operable with any general purpose or special purpose computing system environments, configurations, or devices. Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. An imaging device comprising:
a housing defining an interior space, said housing comprising:
an edge defining at least a portion of an opening to the interior space; and
a cavity formed in said edge;
a cover positionable at least in part on said edge of said housing, said cover overlapping said cavity;
a compliant support positioned in said cavity, said compliant support configured to provide a first force to maintain said cover in a spaced relationship relative to said edge; and
an adhesive component positioned between at least a portion of said edge and said cover, said adhesive component configured to bond said at least a portion of said edge to said cover via said adhesive component when a second force is applied to overcome the first force, wherein said compliant support is retained in said cavity.

2. The imaging device of claim 1, wherein said compliant support is fabricated from a compressible material.

3. The imaging device of claim 2, wherein said compressible material comprises a semi-closed cell EPDM rubber foam.

4. The imaging device of claim 1, wherein said compliant support comprises a cylindrical structure comprising a first end and a substantially parallel second end.

5. The imaging device of claim 4, wherein one of said first and second ends comprises an adhesive backing material to facilitate attachment of said compliant support.

6. The imaging device of claim 1, wherein said compliant support is further configured to facilitate translational movement of said cover relative to said housing.

7. The imaging device of claim 1, wherein said compliant support is further configured to facilitate alignment of said cover to said housing.

8. The imaging device of claim 1, wherein said adhesive component is bonded to one of said housing and said cover, and wherein said compliant support is further configured to provide the first force to maintain the spaced relationship between said adhesive component and the other of said housing and said cover.

9. The imaging device of claim 1, where said adhesive component comprises one or more of the following: a pressure sensitive adhesive, a liquid adhesive, and a heat activated adhesive.

10. The imaging device of claim 1, wherein said interior space is configured to receive at least one imaging component.

11. The imaging device of claim 1, wherein said imaging device comprises one or more of the following: a tablet computing device, a mobile telephone, a gaming console, and a laptop computing device.

12. An enclosure assembly comprising:
a housing comprising a surface having a plurality of cavities formed therein;
a cover positionable on said surface and overlapping said plurality of cavities;
a plurality of compliant supports, wherein a respective compliant support of said plurality of compliant supports is positioned in a respective cavity of said plurality of cavities, said plurality of compliant supports extending beyond said first surface and configured to provide a first force to facilitate maintaining said cover in a spaced relationship relative to said housing; and
an adhesive component positioned between said cover and said surface of said housing and configured to bond said cover to said surface via said adhesive component when a second force is applied to overcome the first force, said plurality of compliant supports being retained in said plurality of cavities.

13. The enclosure assembly of claim 12, wherein said plurality of cavities are spaced about said surface in predefined locations.

14. The enclosure assembly of claim 12, wherein said adhesive component is bonded to said cover, and wherein said plurality of compliant supports are further configured to provide the first force to maintain the spaced relationship between said adhesive component and said housing until the second force is applied.

15. The enclosure assembly of claim 12, wherein said plurality of compliant supports are configured to apply the first force to said cover, and wherein the second force is greater than the first force.

16. The enclosure assembly of claim 12, wherein said enclosure assembly comprises one or more of the following: a tablet computing device, a mobile telephone, a gaming console, and a laptop computing device.

17. A method of assembling an enclosure assembly, said method comprising:
coupling a compliant support to a housing, the compliant support positioned in a cavity formed in a surface of the housing and extending beyond the surface;
placing a cover onto the compliant support, the compliant support maintaining a gap between the cover and the housing;
bonding an adhesive component to one of the housing and the cover in the gap, the gap defining a spaced relationship between the adhesive component and the other of the housing and the cover;
aligning the cover to the housing through translational movement of the cover via the compliant support; and
bonding the cover to the housing via the adhesive component by bringing the cover and the housing into contact with the adhesive component without removing the compliant support from the enclosure assembly.

18. The method of claim 17, wherein the compliant support provides a force to the cover to maintain the spaced relationship between the adhesive component and the other of the housing and the cover during alignment of the cover to the housing.

19. The method of claim 17, wherein bringing the cover and the housing into contact with the adhesive component comprises providing a compressive force to one or more of the housing and the cover to overcome a force generated by the compliant support.

20. The method of claim 17, wherein bringing the cover and the housing into contact with the adhesive component without removing the compliant support from the enclosure assembly comprises compressing the compliant support extending beyond the surface into the cavity of the housing.
